(19) United States
(12) Patent Application Publication
(10) Pub. No.: US 2005/0279870 A1
(43) Pub. Date: Dec. 22, 2005

(54) Methods and apparatus for monitoring rotor pole position

(76) Inventor: Serge Louis Scuccato, Peterborough (CA)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 10/873,543

(22) Filed: Jun. 22, 2004

(51) Int. Cl. B02C 17/24

(52) U.S. Cl. 241/101.2; 241/299

(57) ABSTRACT

A grinding mill synchronous motor that includes an annular stator including a bore, an annular rotor positioned at least partially through the stator bore, the rotor including a plurality of laminations including a plurality of notches, and a first set of proximity sensors including a first proximity sensor and a second proximity sensor positioned approximately one-half notch from the first proximity sensor.

### BACKGROUND OF THE INVENTION

This invention relates generally to mining operations and, more particularly, to methods and apparatus for monitoring a rotor pole position in a grinding mill typically utilized in mining operations.

Grinding mills are utilized to grind ore into a fine particle at which point the specific mineral can be extracted through a chemical process. Different types of mills are used for reducing a particle size of the ore. The mill types include Autogenous (AG) Mills, Semi-Autogenous (SAG) Mills, Ball Mills, Rod Mills, and Regrind Mills. Some mills are driven through gears by using either a single pinion or multiple pinions connected to a common girth gear surrounding the mill. The pinions may be driven at a fixed or a variable speed directly using low speed motors, or indirectly through unit gearboxes using higher speed motors. Other mills are driven directly by having the drive motor rotor mounted directly onto the mill structure. The direct drive motors are powered by a variable speed low frequency drive. This arrangement is referred to as a Gearless Drive and the motor is referred to as a Ring Motor or a Wraparound Motor. At least one known gearless drive grinding mill utilizes a drive system, including a cyclo-converter (CCV), which can generate approximately 25,000 horsepower and a pulse width modulation (PWM) control system. This drive system is particularly suited for grinding mills because the drive system can generate a large horsepower at a relatively low voltage and a relatively low frequency. Both the CCV drive technology and the PWM drive technology requires continuous rotor position information. The choice between fixed speed and variable speed is usually determined by the needs of the grinding process.

During startup and during routine mill maintenance, the gearless grinding mill is generally operated at a speed below 5% of normal operating speed, for example, in the range of approximately 0.0 Hz and approximately 0.5 Hz. To obtain adequate torque and speed control of the grinding mill, both the CCV and the PWM control system require continuous rotor position information. When the gearless grinding mill is operating at speeds greater than approximately 5% of the normal operating speed, the rotor position information may be obtained by monitoring the counter-electromotive force (CEMF) generated by the stator windings.

For geared drive mills, the rotor position and speed can be obtained by mounting a pulse tachometer and an encoder on the grinding mill. The encoder provides the initial motor rotor position when the motor is started, and the pulse tachometer, utilizing a marker pulse, provides the rotor position during normal motor operation. At operational speed greater than 5%, the pulse tachometer information is no longer needed to determine rotor speed.

A gearless mill does not have a shaft, and therefore cannot accommodate or mount a tachometer. The motor rotor information however, is still useful to provide appropriate performance at low speed and during starting. In at least one known gearless grinding mill, the rotor position information is acquired by mounting a toothed wheel around the perimeter of the rotor and mounting a set of proximity sensors on the stator. In another known gearless grinding mill, a plurality of flags are mounted to the motor poles in combination with a sensing box of adequate length and number to generate a continuous pulse train from which the rotor position and speed could be tracked. Both of the known methods above involve additional components, work and/or site alignment time. The toothed wheel option is particularly expensive, as it requires a large amount of installation time. The extra installation time is of particular interest as it represents a major component of the overall cost.

### BRIEF SUMMARY OF THE INVENTION

In one aspect, a grinding mill synchronous motor is provided. The motor includes an annular stator including a bore, an annular rotor positioned at least partially through the stator bore, the rotor including a plurality of laminations including a plurality of notches, and a first set of proximity sensors including a first proximity sensor and a second proximity sensor positioned approximately one-half notch from the first proximity sensor.

In another aspect, a grinding mill assembly is provided. The grinding mill includes a mill shell, a pair of mill bearings supporting the mill shell, and a grinding mill synchronous motor. The motor includes an annular stator including a bore, an annular rotor positioned at least partially through the stator bore, the rotor including a plurality of laminations including a plurality of notches, and a first set of proximity sensors including a first proximity sensor and a second proximity sensor positioned approximately one-half notch from the first proximity sensor.

In a further aspect, a method for determining an annular rotor position and speed is provided. The method includes coupling an annular stator including a bore to a foundation, positioning an annular rotor at least partially through the stator bore, the rotor including a plurality of notches in the laminations, and positioning a first set of proximity sensors including a first proximity sensor and a second proximity sensor approximately one-half notch from the first proximity sensor such that the first proximity sensor and the second proximity sensor generate a pulse at every tooth transition, the pulse used to determine a mill speed and a mill position.

### BRIEF DESCRIPTION OF THE DRAWINGS

FIG. 1 is a side view of a gearless grinding mill that includes a wrap-around drive system.

FIG. 2 is an end view of the gearless grinding mill shown in FIG. 1.

FIG. 3 is a side view of a portion of the wrap-around drive system shown in FIG. 1.

FIG. 4 is a cross-sectional view of a grinding mill illustrating a plurality of proximity sensors.

FIG. 5 is a portion of the grinding mill shown in FIG. 4.

FIG. 6 is a top view of a portion of the rotor shown in FIG. 4.

### DETAILED DESCRIPTION OF THE INVENTION

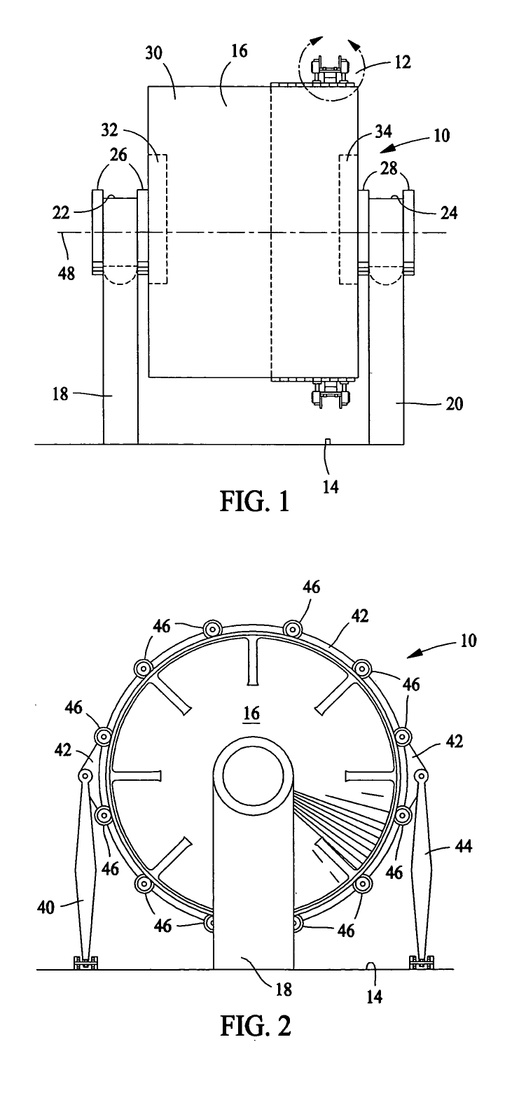

FIG. 1 is a side view of a gearless grinding mill assembly 10 that includes a drive system 12. FIG. 2 is an end view of gearless grinding mill 10 shown in FIG. 1. Grinding mill 10 includes a foundation 14, a mill shell 16, a pair of support members 18 and 20, respectively, mechanically coupled to foundation 14. Support members 18 and 20 include a pair of end bearing housings 22 and 24 mechanically coupled to support members 18 and 20 respectively. End bearing housings 22 and 24 include a pair of mill bearings 26 and 28 which are configured to rotably engage and provide support to mill shell 16.

In an exemplary embodiment, grinding mill 10 is an ore grinding mill and mill shell 16 includes a hollow central portion 30 configured to receive ore to be ground through a first end 32 thereof. The ground ore is then extracted through a second end 34 opposite first end 32 in mill shell 16. Grinding mill 10 also includes a first support member 40 mechanically coupled to a stator 42 and a second support member 44 mechanically coupled to stator 42 to facilitate maintaining stator 42 in an approximately fixed position. Grinding mill 10 also includes a plurality of rollers 46 mechanically coupled to stator 42 such that mill shell 16 is held an approximately equal radial distance from stator 42 and rotates around a central axis 48. To facilitate continuous feed of the ore into mill shell 16, drive system 12 is typically energized before the feed is commenced.

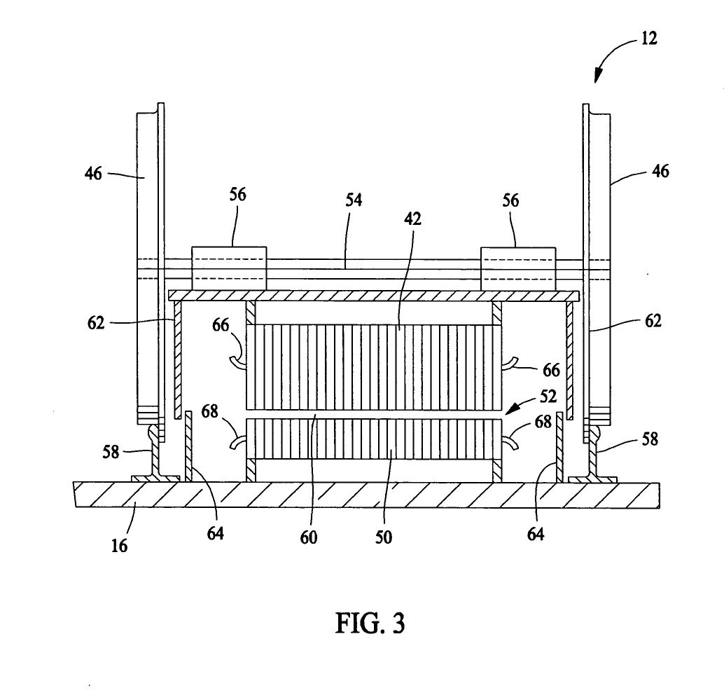

FIG. 3 is a side view of drive system 12. Drive system 12 includes an annular stator 42 mechanically coupled to foundation 14, and an annular rotor 50 mechanically coupled to mill shell 16 and extending axially through a stator bore 52 for rotational movement about central axis 48. In an exemplary embodiment, drive system 12 is a wrap-around drive system 12 such that rotor 50 provides a mechanical energy to mill shell 16 thus driving mill shell 16 in a circular motion around central axis 48. Grinding mill 10 also includes a roller shaft 54 mechanically coupled to stator 42 through a set of bushings 56. Rollers 46 are rotably coupled to a plurality of tracks 58 that are circumferentially attached to mill shell 16 thereby creating an approximately fixed airgap 60 between stator 42 and rotor 50 while rotor 50 is rotating around central axis 48. Tracks 58 facilitate ensuring that mill shell 16, including rotor 50, maintains an approximately fixed position with respect to stator 42 attached to foundation 14.

Drive system 12 also includes a first dust seal 62 mechanically coupled to stator 42, and a second dust seal 64 mechanically coupled to mill shell 16 such that second dust seal 64 rotates with mill shell 16 about central axis 48. First dust seal 62 and second dust seal 64 facilitate preventing dust and dirt from entering the region occupied by rotor 50 and stator 42. In one embodiment, stator 42 includes a plurality of electrical connectors 66 electrically coupled to a cyclo-converter (CCV) (not shown), and rotor 50 includes a plurality of electrical connectors 68 electrically coupled to the CCV. In one embodiment, stator 42 includes a plurality of electrical connectors 66 electrically coupled to a pulse-width modulator (PWM) (not shown), and rotor 50 includes a plurality of electrical connectors 68 electrically coupled to the PWM.

In use, energizing drive system 12 facilitates creating a magnetic field across airgap 60 between rotor 50 and stator 42. The magnetic field generates a plurality of magnetic forces which cause rotor 50 to rotate relative to stator 42. As rotor 50 rotates, mill shell 16 also rotates about axis 48. During rotation of mill shell 16, the ore therein is ground to a desired consistency, and the ground ore is removed from mill shell 16 through second end 34.

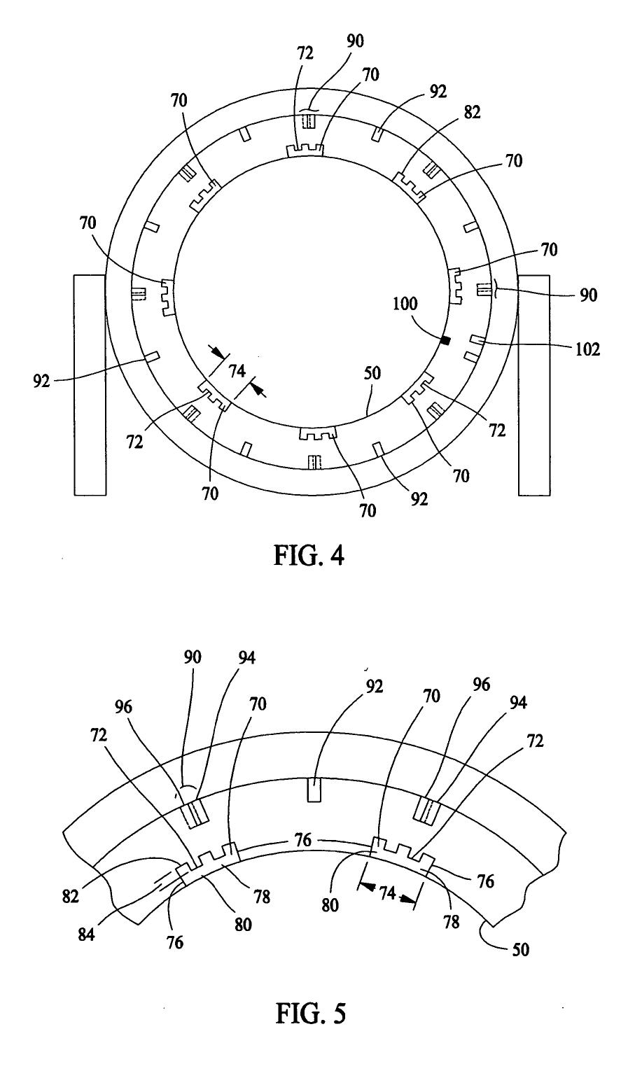

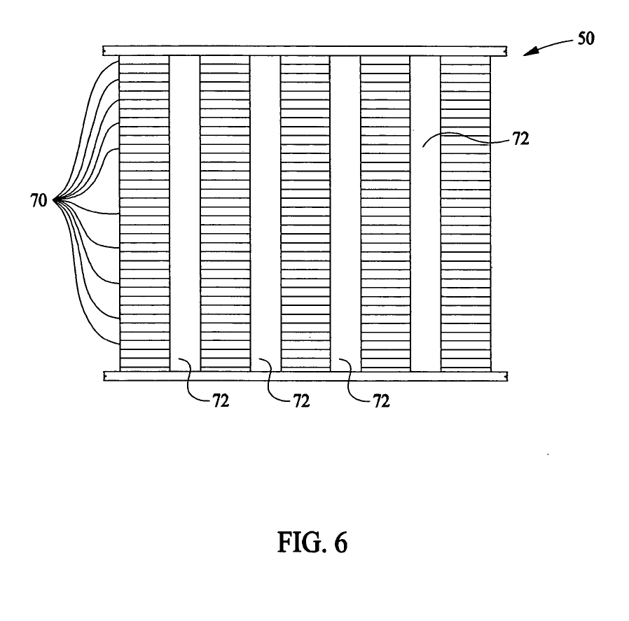

FIG. 4 is a cross-sectional view of grinding mill 10 illustrating a plurality of proximity sensors. FIG. 5 is a portion of grinding mill 10 shown in FIG. 4. FIG. 6 is a top view of a portion of rotor 50. In an exemplary embodiment, rotor 50 includes a plurality of rotor pole laminations 70 that include at least one notch 72 such that when rotor pole laminations 70 are assembled, notches 72 extend along central axis 48. In an exemplary embodiment, a quantity of notches 72 can vary to match a rotor pole length 74 along an air gap circumference. Further, notches 72 are configured such that an end of the rotor pole 76 does not include a notch 72. For example, as shown in FIGS. 4 and 5, two notches 72 are shown for each rotor pole 78. In an exemplary embodiment, notches 72 are spaced approximately equidistantly along a rotor tooth 80. A total quantity of notches 72 per rotor pole 78 can vary to facilitate determining a specific speed and position of mill shell 16. In one embodiment, rotor tooth 80 includes a flat portion 82 that can be used as an air gap sensing reference. A depth 84 of notch 72 can be adjusted to meet any requirements of any electronic control system used with a plurality of proximity sensors. In one embodiment, notch 72 is approximately ¼ inch in depth. In another embodiment, notch 72 is between approximately ⅛ inch in depth and approximately ⅜ inch in depth.

In an exemplary embodiment, stator 42 includes a first set of proximity sensors 90 mechanically coupled to stator 42, and positioned at a plurality of points around rotor 50, and a second set of proximity sensors 92 mechanically coupled to stator 42, and positioned at a plurality of points around rotor 50. Additionally, first set of proximity sensors 90 and second set of proximity sensors 92 are configured to generate a pulse at each tooth transition. Therefore, two pulses are generated as each tooth passes first set of proximity sensors 90 and second set of proximity sensors 92. The pulse count represents a position of rotor 50, i.e. mill shell 16, whereas the pulse rate represents a speed of rotor 50, i.e. mill shell 16.

In one embodiment, first set of proximity sensors 90 includes four proximity sensors mechanically coupled and evenly spaced at four locations around a circumference of stator 42, i.e. at 90°, 180°, 270°, and 360°. In another embodiment, additional proximity sensors can be located in between the above described locations for a total of eight sensor locations, i.e. at 45°, 90°, 135°, 180°, 225°, 270°, 315° and 360°. In another embodiment, first set of proximity sensors 90 includes a plurality of proximity sensors equally spaced around a circumference of stator 42. In an exemplary embodiment, first set of proximity sensors 90 includes a first proximity sensor 94 and a second proximity sensor 96 separated by a distance of approximately one-half notch. Separating proximity sensors 94 and 96 by one-half notch facilitates generating a signal representative of a direction of rotation of rotor 50, and facilitates doubling a pulse rate count, thereby allowing an operator to more accurately determine a position of rotor 50. In one embodiment, second set of proximity sensors 92 are spaced approximately one pole pitch apart such that as first set of proximity sensors 90 no longer detect a first pole, second set of proximity sensors 92 are detecting a second pole. In this manner, an approximately continuous stream of pulses can be generated.

In another embodiment, a marker flag 100 is mounted on rotor 50. In use, as rotor 50 rotates, a proximity sensor 102 mounted on stator 42 identifies each rotation of rotor 50 by emitting a signal when marker flag 100 is detected by marker flag proximity sensor 102. In use, marker flag 100 facilitates correcting any cumulative position error of rotor 50.

Stator-to-rotor airgap 60 is determined using proximity sensors 94 and 96. In use, proximity sensors 94 and 96 provide the electronic control system with an analog signal at the point where at least one of proximity sensors 94 and 96 are over a top of notch 72. Alternately, an average signal voltage of proximity sensors 94 and 96 is used.

In an exemplary embodiment, the electronic control system to support determining the rotor position, rotor speed, and airgap 60 are installed within a motor enclosure which is supplied with clean air and maintained at a positive pressure relative to the surrounding atmosphere.

Rotor pole position technology as described herein facilitates providing rotor position data, mill speed data, and rotor-to-stator airgap data while reducing additional site assembly and alignment which is required in some known systems. In use, the rotor position data is used by a drive control, the rotor speed data is used by a drive for speed control at extremely low speeds, a Mill Auxiliary Control System, and a Mill Distributed Control System (DCS). Rotor-to-stator airgap 60 is monitored by a Mill System Protection System and is also used for diagnostic purposes.

Rotor pole position technology as described herein also facilitates eliminating the supply, installation and alignment cost of a relatively large diameter traditional toothed wheel, and facilitates reducing installation time of a mill. Additionally, installing proximity sensors as described herein facilitates gapping the pole segments at the proper location resulting in a reduction of installation time. Further, a high pulse count facilitates an increase in accuracy of pole position information and facilitates generating a smoother drive torque, thereby reducing or elimination torque jitter. Mill speed and position can be taken from any one set of sensors located around the stator therefore providing for built-in spares, and increasing sensor better availability. The dual-sensors provide actual and direct measurement of mill rotation direction. A rotor mounted flag can be used to accurately trigger at each mill rotation and be used to correct the accumulated mill pole position. The derived information on rotor position, speed, gap and mill number of turns can be used for other functions by the grinding system.

While the invention has been described in terms of various specific embodiments, those skilled in the art will recognize that the invention can be practiced with modification within the spirit and scope of the claims.

1. A grinding mill synchronous motor comprising;
an annular stator comprising a bore;
an annular rotor positioned at least partially through said stator bore, said rotor comprising a plurality of laminations comprising a plurality of notches; and
a first set of proximity sensors comprising a first proximity sensor and a second proximity sensor positioned approximately one-half notch from said first proximity sensor.

2. A synchronous motor in accordance with claim 1 wherein said stator further comprises a second set of proximity sensors spaced approximately one pole pitch apart from said first set of proximity sensors such that as said first set of proximity sensors no longer detect a first pole, said second set of proximity sensors are detecting a second pole.

3. A synchronous motor in accordance with claim 1 wherein said laminations are oriented in an approximately mill axial direction.

4. A synchronous motor in accordance with claim 1 wherein said motor further comprises:
a marker flag coupled to said rotor, and
a marker flag proximity sensor coupled to said stator, said stator marker flag proximity sensor configured to detect said rotor mounted flag and trigger at each mill rotation.

5. A synchronous motor in accordance with claim 1 wherein said first proximity sensor and said second proximity sensor are configured to generate a pulse at each tooth transition, said pulses used to determine a mill speed and a mill position.

6. A synchronous motor in accordance with claim 1 wherein said notches are spaced approximately equidistantly along a rotor tooth.

7. A synchronous motor in accordance with claim 6 wherein said rotor tooth includes a flat portion used as an air gap sensing reference.

8. A grinding mill assembly comprising:
a mill shell;
a pair of mill bearings supporting said mill shell; and
a synchronous motor comprising:
an annular stator comprising a bore, said annular stator coupled to a foundation;
an annular rotor positioned at least partially through said stator bore, said rotor comprising a plurality of laminations comprising a plurality of notches; and
a first set of proximity sensors comprising a first proximity sensor and a second proximity sensor positioned approximately one-half notch from said first proximity sensor.

9. A grinding mill assembly in accordance with claim 8 wherein said stator further comprises a second set of proximity sensors spaced approximately one pole pitch apart from said first set of proximity such that as said first set of proximity sensors no longer detect a first pole, said second set of proximity sensors are detecting a second pole.

10. A grinding mill assembly in accordance with claim 8 wherein said laminations are oriented in an approximately mill axial direction.

11. A grinding mill assembly in accordance with claim 8 wherein said motor further comprises:
a marker flag coupled to said rotor, and
a marker flag proximity sensor coupled to said stator, said stator marker flag proximity sensor configured to detect said rotor mounted flag and trigger at each mill rotation.

12. A grinding mill assembly in accordance with claim 8 wherein said first proximity sensor and said second proximity sensor are configured to generate a pulse at each tooth transition, said pulse used to determine a mill speed and a mill position.

13. A grinding mill assembly in accordance with claim 8 wherein said notches are spaced approximately equidistantly along a rotor tooth.

14. A grinding mill assembly in accordance with claim 13 wherein said rotor tooth includes a flat portion used as an air gap sensing reference.

15. A method for determining an annular rotor position and speed, said method comprising;
coupling an annular stator including a bore to a foundation;
positioning an annular rotor at least partially through the stator bore, the rotor including a plurality of notches in the laminations; and
positioning a first set of proximity sensors including a first proximity sensor and a second proximity sensor approximately one-half notch from the first proximity sensor such that the first proximity sensor and the second proximity sensor generate a pulse at every tooth transition, the pulse used to determine a mill speed and a mill position.

16. A method in accordance with claim 15 further comprising spacing a second set of proximity sensors one pole pitch apart from the first set of proximity sensors such that as said first set of proximity sensors no longer detect a first pole, said second set of proximity sensors are detecting a second pole.

17. A method in accordance with claim 15 further comprising orienting the laminations in an approximately mill axial direction.

18. A method in accordance with claim 15 further comprising:
coupling a marker flag to the rotor, and
coupling a marker flag proximity sensor to the stator, the stator marker flag proximity sensor configured to detect the rotor mounted flag and trigger at each mill rotation.

19. A method in accordance with claim 15 further comprising generating a pulse at every tooth transition using the first proximity sensor and the second proximity sensor.

20. A method in accordance with claim 19 further comprising equidistantly spacing the notches along a rotor tooth.

21. A method in accordance with claim 20 wherein said equidistantly spacing the notches along a rotor tooth further comprises equidistantly spacing the notches along a rotor tooth including a flat portion used as an air gap sensing reference.
